(19) United States
(12) Patent Application Publication
(10) Pub. No.: US 2016/0246231 A1
(43) Pub. Date: Aug. 25, 2016

(54) FIXING DEVICE AND IMAGE FORMING APPARATUS

(71) Applicant: FUJI XEROX CO., LTD., Tokyo (JP)

(72) Inventors: Motoi NOYA, Kanagawa (JP); Masaki NAGATA, Kanagawa (JP); Nobuyoshi KOMATSU, Kanagawa (JP); Yusuke KANAI, Kanagawa (JP)

(73) Assignee: FUJI XEROX CO., LTD., Tokyo (JP)

(21) Appl. No.: 14/840,499

(22) Filed: Aug. 31, 2015

(30) Foreign Application Priority Data
Feb. 24, 2015 (JP) 2015-033960

(51) Int. Cl. G03G 15/20

(52) U.S. Cl. CPC G03G 15/2085; G06K 15/16; G06K 15/129

(57) ABSTRACT

A fixing device includes a fixing roller, a rotatable endless belt forming a nip between the fixing roller and the belt, a heating member whose heat source heats the nip, a support member disposed in the belt to face the fixing roller and having a surface having a substantially non-arc shape in a rotation direction of the belt and being in contact with an inner surface of the belt to sandwich the belt between the support member and the fixing roller, and a pressing member including guiding members that support and guide end edges of the belt. The guiding members each have a groove having inner and outer walls that guide an edge of the belt in a direction in which a rotation axis of the belt extends and a substantially arc-shaped bottom surface that extends around the axis and along which an end surface of the belt slides.

### CROSS-REFERENCE TO RELATED APPLICATIONS

This application is based on and claims priority under 35 USC 119 from Japanese Patent Application No. 2015-033960 filed Feb. 24, 2015.

### BACKGROUND

### Technical Field

The present invention relates to a fixing device and an image forming apparatus.

### SUMMARY

According to an aspect of the invention, there is provided a fixing device that fixes a toner image onto a sheet, which is transported while holding the toner image, by applying heat and pressure to the sheet, the fixing device including a fixing roller that is driven so as to rotate, an endless belt that forms a contact region between the fixing roller and the endless belt and that rotates as a result of being driven by the fixing roller, which rotates, a heating member that includes a heat source that heats the contact region, a support member that is disposed at a position in a space enclosed by the belt, the position facing the fixing roller, and that has a support surface, which has a substantially non-arc shape in a direction in which the belt rotates and which is in contact with an inner surface of the belt in such a manner that the belt is sandwiched between the support member and the fixing roller, and a pressing member that includes a pair of guiding members that support and guide end edge portions of the belt in a direction in which a rotation axis of the belt extends. Each of the guiding members is a member having a guiding groove that has an inner guiding wall that guides an edge of the belt in the direction in which the rotation axis of the belt extends from an area inside the belt, an outer guiding wall that guides the edge of the belt from an area outside the belt, and a bottom surface that extends around the rotation axis in such a manner as to have a substantially arc shape and along which an end surface of the belt slides.

### BRIEF DESCRIPTION OF THE DRAWINGS

An exemplary embodiment of the present invention will be described in detail based on the following figures, wherein:

FIG. 1 is a diagram illustrating an internal structure of a printer, which is an example of an image forming apparatus according to the exemplary embodiment of the present invention;

FIG. 2 is a diagram illustrating a configuration of a fixing unit, which is included in the printer illustrated in FIG. 1, in a state of being removed from the printer;

FIG. 3 is a perspective view illustrating one of guiding members in a state where an end portion of a pressure belt on one side in a direction in which a rotation axis of the pressure belt extends is fitted to the guiding member;

FIG. 4 is a perspective view illustrating a portion of the guiding member on the inner surface side into which the pressure belt is fitted;

FIG. 5 is a sectional view taken along line V-V of FIG. 4; and

FIG. 6 is a diagram illustrating an inner surface of the guiding member.

### DETAILED DESCRIPTION

An exemplary embodiment of the present invention will be described below.

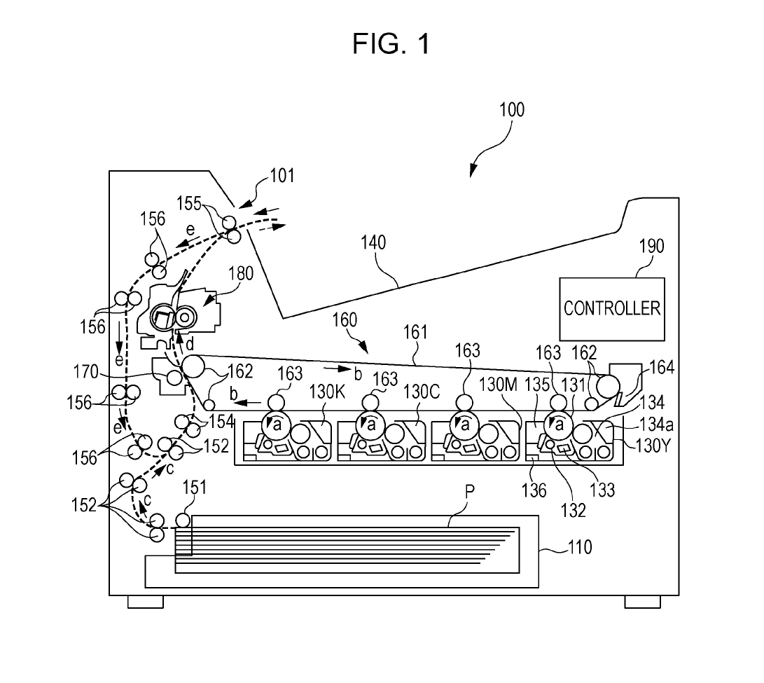

FIG. 1 is a diagram illustrating an internal structure of a printer 100, which is an example of an image forming apparatus according to the exemplary embodiment of the present invention. The printer 100 includes a fixing unit 200, which is an example of a fixing device according to the exemplary embodiment of the present invention.

A drawer-type sheet tray 110 is disposed in a lower portion of the printer 100, and sheets P, each of which is to be used for a print operation and each of which has not yet been used, are accommodated in the sheet tray 110 in such a manner as to be stacked on top of one another. When an image printing operation is performed, the sheets P in the sheet tray 110 are picked up one by one by a pickup roller 151 and transported by transport rollers 152. Details of transportation of the sheets P will be described later.

Four image forming engines 130 are mounted in the printer 100. The four image forming engines 130 are cartridge-type image forming engines and are individually removable from the printer 100. The image forming engines 130 include image forming engines 130Y, 130M, 130C, and 130K. The image forming engines 130 contain different monochromatic color toners, and each of the image forming engines 130 forms a monochromatic color toner image by using the corresponding monochromatic color toner.

In the following description, when the image forming engines 130 are described in such a manner as to be distinguished in terms of toner color, the letters Y, M, C, and K, which represent the toner colors (yellow, magenta, cyan, and black), will be given to the reference numeral 130, which represents each of the image forming engines.

In the present exemplary embodiment, the image forming engines 130 have the same configuration. Each of the image forming engines 130 includes a photoconductor 131 that rotates in the direction of arrow a, a charger 132, an exposure unit 133, a developing unit 134, and a cleaner 135. The charger 132, the exposure unit 133, the developing unit 134, and the cleaner 135 are disposed around the photoconductor 131.

Each of the chargers 132 uniformly charges a surface of the corresponding photoconductor 131.

Each of the exposure units 133 radiates exposure light, which is modulated on the basis of image data, onto the corresponding photoconductor 131 so as to form an electrostatic latent image on the photoconductor 131. Image data representing a monochromatic color image is input to each of the image forming engines 130, the monochromatic color image being formed of the color toner contained in the corresponding image forming engine 130. Then, exposure light, which is modulated on the basis of the image data representing the corresponding monochromatic color image, is radiated from each of the exposure units 133, and an electrostatic latent image corresponding to the monochromatic color image is formed on the corresponding photoconductor 131.

Each of the developing units 134 develops an electrostatic latent image on the corresponding photoconductor 131 with the corresponding toner and forms a monochromatic color toner image on the photoconductor 131. Each of the developing units 134 includes a toner cartridge 134a. Each of the toner cartridges 134a contains the monochromatic color toner for the corresponding developing unit 134. The toner in each of the toner cartridges 134a is supplied to the corresponding developing unit 134 and used for formation of a toner image. Each of the toner cartridges 134a may individually be replaced and is to be replaced with a new toner cartridge 134a when the toner cartridge 134a is empty.

An intermediate transfer unit 160 is disposed above the image forming engines 130. The intermediate transfer unit 160 includes an endless intermediate transfer belt 161, plural support rollers 162 that support the intermediate transfer belt 161, four first transfer rollers 163, and a cleaner 164.

The intermediate transfer belt 161 is supported by the plural support rollers 162 and moves circularly in the direction of arrow b while passing through a movement path extending along the four image forming engines 130.

The four first transfer rollers 163 are disposed at positions facing the photoconductors 131 of the image forming engines 130 with the intermediate transfer belt 161 interposed between the first transfer rollers 163 and the photoconductors 131, and each of the first transfer rollers 163 serves to transfer a toner image formed on the corresponding photoconductor 131 onto the intermediate transfer belt 161.

Toner images that are formed on the photoconductors 131, which are included in the four image forming engines 130, are sequentially transferred onto the intermediate transfer belt 161, which moves in the direction of arrow b, in such a manner as to be superposed with one another by operation of the first transfer rollers 163.

After the toner images have been transferred, residual toner and the like that remain on the surfaces of the photoconductors 131 are removed by the corresponding cleaners 135.

Each of the image forming engines 130 includes a memory 136. In each of the memories 136, various information items related to the corresponding image forming engine 130, such as the color of the toner used in the image forming engine 130 and an accumulated operation time of the image forming engine 130 from the beginning of use are recorded. When the image forming engines 130 are mounted in the printer 100, the contents of the memories 136 are read by the printer 100, and the contents of the memories 136 are rewritten as necessary.

Toner images that have been sequentially transferred to the intermediate transfer belt 161 in such a manner as to be superposed with one another are transferred, by operation of a second transfer roller 170, onto one of the sheets P that has been transported to the position of the second transfer roller 170 in accordance with the timing at which the toner images are delivered to the position of the second transfer roller 170. The fixing unit 200 applies heat and pressure to the sheet P on which the toner images have been transferred, and as a result, an image formed of the toner images, which have been fixed to the sheet P, is printed on the sheet P. The sheet P is ejected to a sheet-exit tray 140 by sheet ejection rollers 155.

On the other hand, after the toner images have been transferred, residual toner and the like that remain on a surface of the intermediate transfer belt 161 are removed by the cleaner 164.

A transport path along which the sheets P are to be transported in a print operation will now be described.

When a print operation is performed, one of the sheets P is picked up from the sheet tray 110 by the pickup roller 151 and is transported in the direction of arrow c by the transport rollers 152 until an end of the sheet P reaches timing-adjustment rollers 154. After that, the sheet P is sent out by the timing-adjustment rollers 154 so as to be delivered to the position of the second transfer roller 170 in accordance with the timing at which toner images, which have been transferred to the intermediate transfer belt 161, are delivered to the position of the second transfer roller 170, and the toner images are transferred onto the sheet P by operation of the second transfer roller 170. The sheet P, to which the toner images have been transferred, is further transported in the direction of arrow d, and the toner images are fixed onto the sheet P by the fixing unit 200. Then, the sheet P is ejected to the sheet-exit tray 140 by the sheet ejection rollers 155.

In the case of performing two-sided printing in which an image is printed on both first and second surfaces of one of the sheets P, a portion of the sheet P having an image only printed on the first surface thereof is ejected to the sheet-exit tray 140 by the sheet ejection rollers 155, and then, the portion of the sheet P, which has been ejected, is drawn into the printer 100 again as a result of the sheet ejection rollers 155 rotating in a reverse direction.

The sheet P, which has drawn in the printer 100, is transported in the direction of arrow e by transport rollers 156 and further transported by the transport rollers 152, and the other end of the sheet P reaches the timing-adjustment rollers 154. A process that is to be subsequently performed is similar to that in the case of printing an image on the first surface of the sheet P, and the sheet P having an image printed on the second surface is ejected to the sheet-exit tray 140.

The printer 100 includes a controller 190, and the controller 190 performs overall control of the printer 100.

The configuration of the fixing unit 200 will now be described.

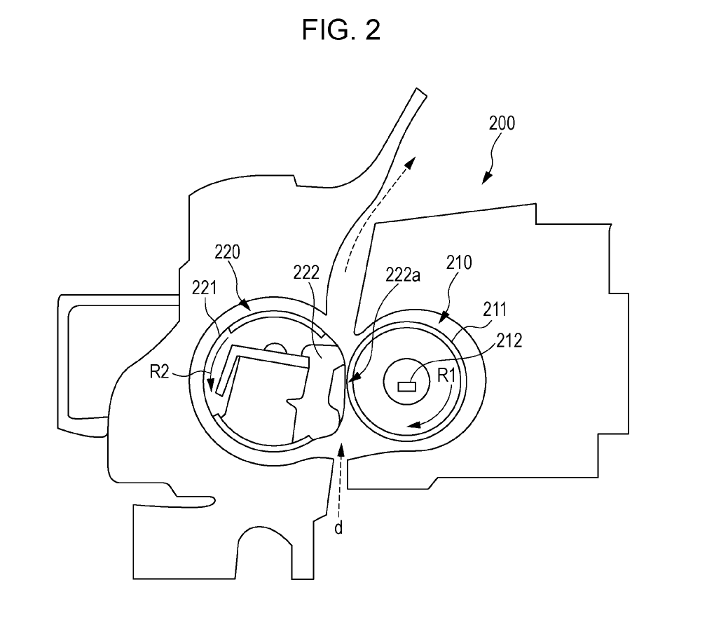

FIG. 2 is a diagram illustrating the configuration of the fixing unit 200, which is included in the printer 100 illustrated in FIG. 1, in a state of being removed from the printer 100.

As described above, the fixing unit 200 is a device that applies heat and pressure to one of the sheets P that has been transported while holding toner images, which have been transferred thereto by operation of the second transfer roller 170 illustrated in FIG. 1, so as to fix the toner images onto the sheet P. The fixing unit 200 corresponds to an example of the fixing device according to the exemplary embodiment of the present invention.

The fixing unit 200 includes a heating member 210 and a pressing member 220.

The heating member 210 includes a heating roller 211 and a heat source 212 that is disposed in a space enclosed by the heating roller 211. The heating roller 211 is a roller that is configured to be driven so as to rotate in the direction of arrow R1.

The pressing member 220 includes an endless pressure belt 221 and a support member 222.

The pressure belt 221 is an endless belt that is in contact with the heating roller 211 and that is driven and rotated in the direction of arrow R2 as a result of receiving a rotational driving force from the heating roller 211.

The support member 222 is disposed at a position in a space enclosed by the pressure belt 221, the position facing the heating roller 211, and is in contact with the inner surface of the pressure belt 221 in such a manner that the pressure belt 221 is sandwiched between the support member 222 and the heating roller 211. In order to press the pressure belt 221 against the heating roller 211 in a necessary nip region, a support surface 222a of the support member 222 that is in contact with the inner surface of the pressure belt 221 is recessed, and the overall shape of the support surface 222a is a non-arc shape or a substantially non-arc shape.

Thus, although the pressure belt 221 is a belt that normally has a cylindrical shape, since the pressure belt 221 is pressed against the heating roller 211 by the support surface 222a of the support member 222, which has a non-arc shape or a substantially non-arc shape, portions of the pressure belt 221 in the nip region, which is defined between the support member 222 of the pressure belt 221 and the heating roller 211, and the peripheral regions are pressed and deformed in such a manner that the pressure belt 221 has a non-circular shape.

The pressure belt 221 may sometimes move in a serpentine manner in a direction in which the rotation axis thereof extends (direction perpendicular to FIG. 1 and FIG. 2) as a result of rotating, and thus, a pair of guiding members 230 that suppress such serpentine movement of the pressure belt 221 are disposed at positions corresponding to the ends of the pressure belt 221 in the direction in which the rotation axis of the pressure belt 221 extends (hereinafter referred to as rotation axis direction). The pair of guiding members 230 serve as stoppers that are brought into contact with end surfaces of the pressure belt 221 in the rotation axis direction such that the pressure belt 221 will not further move in a serpentine manner.

A feature of the present exemplary embodiment is the guiding members 230, which will be described in detail below.

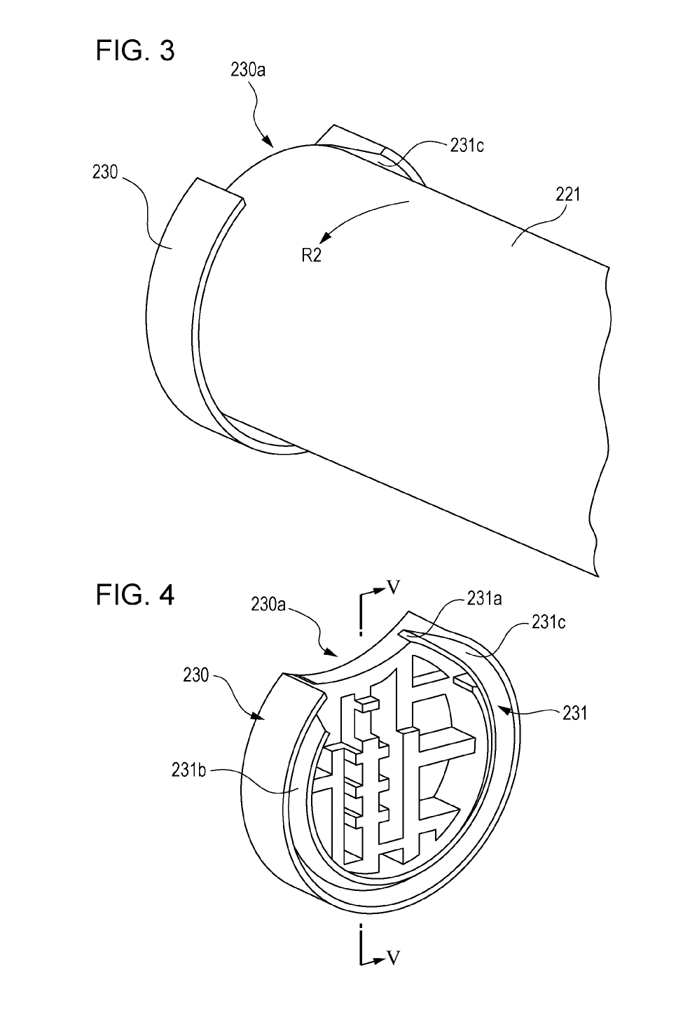

FIG. 3 is a perspective view illustrating one of the guiding members 230 in a state where an end portion of the pressure belt 221 on one side in the rotation axis direction is fitted to the guiding member 230. The pressure belt 221 illustrated in FIG. 3 is not pressed against the heating roller 211 (see FIG. 2) and has a cylindrical shape.

The guiding member 230 has a cutout portion 230a (see also FIG. 4) formed by cutting out the guiding member 230, the cutout portion 230a facing the heating roller 211, and the guiding member 230 excluding the cutout portion 230a has a shape that allows an end edge portion of the pressure belt 221 in the rotation axis direction to be fitted into the guiding member 230.

FIG. 4 is a perspective view illustrating a portion of one of the guiding members 230 on the inner surface side into which the pressure belt 221 is fitted.

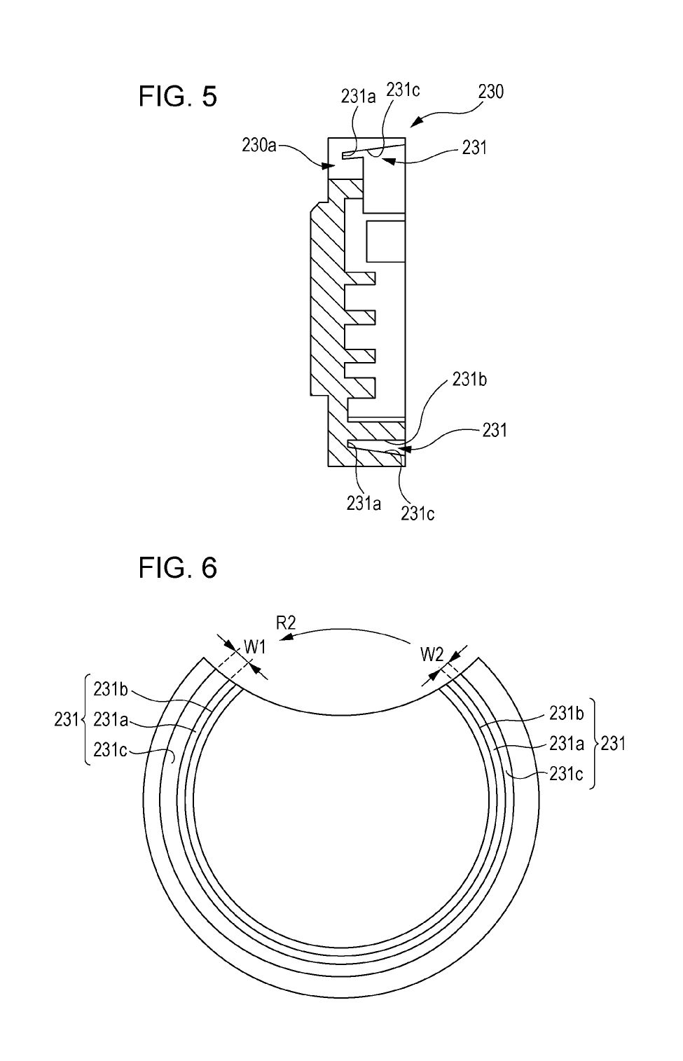

FIG. 5 is a sectional view taken along line V-V of FIG. 4.

A guiding groove 231 that has a bottom surface 231a extending around the rotation axis of the pressure belt 221 in such a manner as to have an arc shape or a substantially arc shape is formed in the guiding member 230. The end edge portion of the pressure belt 221 is fitted into the guiding groove 231, and the pressure belt 221 rotates while being guided by the guiding member 230.

The guiding groove 231 has an inner guiding wall 231b that guides the end edge portion of the pressure belt 221 from an area inside the pressure belt 221 and an outer guiding wall 231c that guides the end edge portion of the pressure belt 221 from an area outside the pressure belt 221. The end edge portion of the pressure belt 221 is fitted to the guiding groove 231 of the guiding member 230, and when the pressure belt 221 moves in a serpentine manner toward the side on which the guiding member 230 is disposed, an end surface of the pressure belt 221 abuts against the bottom surface 231a of the guiding groove 231 and slides along the bottom surface 231a, and as a result, a further serpentine movement of the pressure belt 221 toward the side on which the guiding member 230 is disposed is suppressed.

The inner guiding wall 231b of the guiding groove 231 is parallel to the rotation axis of the pressure belt 221 and has an arc shape. On the other hand, the outer guiding wall 231c is formed of a surface inclined with respect to the rotation axis in such a manner that the diameter thereof increases with increasing distance from the bottom surface 231a. The outer guiding wall 231c is tapered in a direction away from the start of the guiding groove 231. Thus, even when the pressure belt 221 has a non-circular shape as a result of being pressed against the heating roller 211, the shape of the pressure belt 221 is naturally corrected to a circular shape in a direction from a center portion of the pressure belt 221 toward the end portion of the pressure belt 221 in the rotation axis direction, and the end surface of the pressure belt 221 is caused to have a circular shape and pressed against the bottom surface 231a, which has an arc shape or a substantially arc shape.

FIG. 6 is a diagram illustrating the inner surface of one of the guiding members 230. For ease of understanding, the tapered shape of the outer guiding wall 231c is exaggeratedly illustrated in FIG. 6.

The pressure belt 221 (not illustrated in FIG. 6) rotates in the direction of arrow R2. Regarding the outer guiding wall 231c of the guiding groove 231 of the guiding member 230, a portion of the outer guiding wall 231c on the side on which the pressure belt 221 passes through the cutout portion 230a and enters the guiding groove 231 as a result of rotating with respect to the rotation axis of the pressure belt 221 is formed of an inclined surface having an inclination angle larger than that of an inclined surface that forms a portion of the outer guiding wall 231c on the side on which the pressure belt 221 exits the guiding groove 231 to the cutout portion 230a with respect to the rotation axis of the pressure belt 221.

In other words, as illustrated in FIG. 6, when the inner surface of the guiding member 230 is viewed from the rotation axis direction, a width (the distance between one end of the outer guiding wall 231c connected to the bottom surface 231a and the other end of the outer guiding wall 231c on the side opposite to the bottom surface 231a in a radial direction of the guiding member 230) W1 of the pressure belt 221 on the side on which the pressure belt 221 enters the guiding groove 231 is larger than a width W2 on the side on which the pressure belt 221 exits the guiding groove 231.

Consequently, also in a rotation direction (direction of arrow R2) of the pressure belt 221, part of the end edge portion of the pressure belt 221, which corresponds to the cutout portion 230a and still has a non-arc shape enters the guiding groove 231 while being naturally corrected so as to have an arc shape.

As described above, in each of the guiding members 230 according to the present exemplary embodiment, the bottom surface 231a against which an end surface of the pressure belt 221 abuts has an arc shape or a substantially arc shape that is less likely to cause buckling or deformation of the pressure belt 221, and the outer guiding wall 231c is tapered in order to naturally correct the shape of the pressure belt 221 from a non-circular shape to a circular shape in a direction from a center portion of the pressure belt 221 toward the end portion of the pressure belt 221 in the rotation axis direction. In addition, the guiding groove 231 whose start through which the pressure belt 221 enters the guiding groove 231 is widened is formed in order to naturally correct the shape of an end edge portion of the pressure belt 221 from a non-circular shape to a circular shape in the rotation direction (direction of arrow R2) of the pressure belt 221.

Thus, the probability of buckling or breakage occurring in an end edge portion of the pressure belt 221 is significantly reduced compared with a structure in which an end surface of the pressure belt 221 abuts against the bottom surface 231a while having a non-circular shape.

Note that, although one guiding member 230 of the pair of guiding members 230, each of which is disposed at the corresponding end of the pressure belt 221 in the rotation axis direction, has been described above, the other guiding member 230 is formed so as to be plane-symmetrical to the guiding member 230, which has been described above, and the guiding groove 231 whose width on the side on which the pressure belt 221 enters the guiding groove 231 in the rotation direction of the pressure belt 221 is set to be large is formed in each of the guiding members 230.

Note that, although the case where the present invention is applied to the printer 100 illustrated in FIG. 1 has been described above, the present invention may be applied to a variety of image forming apparatuses, such as printers and copying machines each of which requires a fixing unit that fixes a toner image onto a sheet, which is transported while holding the toner image, by applying heat and pressure to the sheet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device that fixes a toner image onto a sheet, which is transported while holding the toner image, by applying heat and pressure to the sheet, the fixing device comprising:
a fixing roller that is driven so as to rotate;
an endless belt that forms a contact region between the fixing roller and the endless belt and that rotates as a result of being driven by the fixing roller, which rotates;
a heating member that includes a heat source that heats the contact region;
a support member that is disposed at a position in a space enclosed by the belt, the position facing the fixing roller, and that has a support surface, which has a substantially non-arc shape in a direction in which the belt rotates and which is in contact with an inner surface of the belt in such a manner that the belt is sandwiched between the support member and the fixing roller; and
a pressing member that includes a pair of guiding members that support and guide end edge portions of the belt in a direction in which a rotation axis of the belt extends,
wherein each of the guiding members is a member having a guiding groove that has an inner guiding wall that guides an edge of the belt in the direction in which the rotation axis of the belt extends from an area inside the belt, an outer guiding wall that guides the edge of the belt from an area outside the belt, and a bottom surface that extends around the rotation axis in such a manner as to have a substantially arc shape and along which an end surface of the belt slides.

2. The fixing device according to claim 1,
wherein the outer guiding wall is formed of a surface inclined with respect to the rotation axis in such a manner that the diameter of the outer guiding wall increases with increasing distance from the bottom surface.

3. The fixing device according to claim 2,
wherein the guiding groove is not present on a side on which the fixing roller is disposed and is a groove extending in a substantially arc shape in a region excluding a region facing the fixing roller, and
a portion of the outer guiding wall on a side on which the belt enters the guiding groove as a result of rotating is formed of an inclined surface having an inclination angle with respect to the rotation axis larger than an inclination angle of an inclined surface that forms a portion of the outer guiding wall on a side on which the belt exits the guiding groove.

4. An image forming apparatus comprising:
the fixing device according to claim 1,
wherein the image forming apparatus forms a toner image on a sheet and causes the sheet to pass through the contact region formed between the fixing roller and the endless belt so as to form an image, which is formed of the toner image fixed to the sheet, on the sheet.

5. An image forming apparatus comprising:
the fixing device according to claim 2,
wherein the image forming apparatus forms a toner image on a sheet and causes the sheet to pass through the contact region formed between the fixing roller and the endless belt so as to form an image, which is formed of the toner image fixed to the sheet, on the sheet.

6. An image forming apparatus comprising:
the fixing device according to claim 3,
wherein the image forming apparatus forms a toner image on a sheet and causes the sheet to pass through the contact region formed between the fixing roller and the endless belt so as to form an image, which is formed of the toner image fixed to the sheet, on the sheet.
